(19) United States
(12) Patent Application Publication
(10) Pub. No.: US 2006/0274633 A1
(43) Pub. Date: Dec. 7, 2006

(54) Multi-stack information carrier

(76) Inventors: Erwin Rinaldo Meinders, Eindhoven (NL); Martinus Bernardus Van Der Mark, Eindhoven (NL); Johannes Theodorus Adriaan Wilderbeek, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/546,319

(22) PCT Filed: Feb. 16, 2004
(86) PCT No.: PCT/IB04/00467

§ 371 Date: Aug. 19, 2005

(30) Foreign Application Priority Data
Feb. 27, 2003 (EP) 03290471.6

(51) Int. Cl. G11B 9/00

(52) U.S. Cl. 369/126

(57) ABSTRACT

The invention relates to an information carrier comprising at least two information stacks. Each stack comprises a first electrode (11, 15), a second electrode (13, 17) and an information layer (12, 16) between the first and second electrodes. The information layer comprises molecules which can be rotated when a suitable potential difference is applied between the first and second electrodes.

### FIELD OF THE INVENTION

The present invention relates to a multi-stack optical information carrier.

The present invention also relates to a scanning device for scanning a multi-stack optical information carrier.

The present invention also relates to a method of reading from, a method of recording on and a method of erasing a multi-stack optical information carrier.

The present invention is particularly relevant for optical data storage and optical disc apparatuses for reading and/or recording data from and/or on multi-stack optical discs.

### BACKGROUND OF THE INVENTION

In the field of optical recording, increasing the capacity of the information carrier is the trend. An already investigated way for increasing the data capacity consists in using a plurality of information layers in the information carrier. For example, a DVD (Digital Video Disc) can comprise two information layers. Information is recorded on or read from an information layer by means of an optical beam, using local refractive index variations or the presence of surface relief structures.

However, the number of information layers in such an information carrier is limited. First, because the light intensity of the optical beam decreases with each additional addressed layer. Actually, when the optical beam has to pass many layers for addressing a layer, interaction takes place in the non-addressed layers, reducing the intensity of the optical beam. Additionally, the local refractive index variations of the written information patterns in the non-addressed layers cause refraction, absorption and/or scattering of the traversing light-beam, leading to deteriorated writing and reading.

Hence, conventional optical data storage techniques are not suitable for multi-layer information carriers, in particular for information carriers comprising more than three layers.

### SUMMARY OF THE INVENTION

It is an object of the invention to provide an information carrier, which can comprise an increased number of layers.

To this end, the invention proposes an information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes.

According to the invention, the information layers comprise molecules which can be rotated by means of a potential difference. The optical properties of an information layer of an information stack can thus be changed in that a potential difference between the two electrodes of this information stack is applied. Hence, by application of a suitable potential differences to the stacks, it is possible to scan one layer having optical properties suitable for interacting with an optical beam, whereas the optical properties of the other layers are chosen so that the interactions between these non-addressed layers and the optical beam are reduced. As a consequence, the total transmission of light through all the information stacks is increased such that the number of layers can be increased.

In an advantageous embodiment of the invention, the molecules in the information layer are liquid crystal molecules which can be rotated when subjected to an electric field created by the potential difference applied between the first and second electrodes.

In another advantageous embodiment of the invention, the molecules comprise a charged substituent which can be rotated when subjected to a current created by the potential difference applied between the first and second electrodes.

In a preferred embodiment of the invention, the information layer can be locally degraded by means of an optical beam in order to write information on the information layer. The information layer may be, for example, annealed, altered, molten, fixed or photochemically deteriorated by means of the optical beam in order to write information, such that a further orientation change of the molecules of the information layer is no longer possible. The degraded parts of the layer remain essentially transparent, whatever the potential difference applied between the first and second electrodes. According to this embodiment, information can be written by a user on the information carrier in that certain areas of the information stack are disabled from changing their optical properties.

In another preferred embodiment of the invention, the first electrode has an electrical conductance which can be locally reduced by means of an optical beam in order to write information in the information stack. According to this embodiment, information can be written by a user on the information carrier in that certain areas of the information stack are disabled from changing their optical properties.

Advantageously, the information layer has a decomposition temperature which is higher than the temperature at which the electrical conductance of the first electrode is reduced. This allows a writing of information in an information stack, without degradation of the information layer.

Preferably, the information stack further comprises a thermal insulation layer between the first electrode and the information layer. In this case, writing of information without degrading the information layer is possible, even if the information layer has a decomposition temperature which is lower than or equal to the temperature at which the electrical conductance of the first electrode is reduced. If this insulation layer is an electrically insulating layer, the embodiment based on molecules that rotate under the influence of an electric field can be used. If an electrically conducting layer is used, the embodiment based on molecules that rotate under the influence of an electrical current can also be used.

In another preferred embodiment of the invention, the information layer comprises a matrix comprising two types of surface-charged colloidal particles, one with negative charge and one with positive charge, said surface-charged colloidal particles comprising liquid crystal molecules, said matrix having a viscosity which can be locally reduced by means of an optical beam in order to write information on the information layer. According to this embodiment, information can be written by a user, then erased and rewritten on the information carrier.

The invention also relates to an optical scanning device for scanning an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said optical scanning device comprising means for generating the optical beam, means for focusing said optical beam on an information layer and means for applying a potential difference between the first and second electrodes of an information stack.

Advantageously, the optical device comprises a damper for receiving the information carrier, said damper comprising contacts for applying a potential difference between the first and second electrodes of a stack. Hence, a conventional optical device may be used for scanning information carriers according to the invention, in that contacts in the damper of said conventional optical device, and means for applying potential differences between these contacts are added.

The invention also relates to a method of reading information from an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the steps of applying a potential difference between the first and second electrodes of the information stack from which information is to be read and focusing the optical beam on the information layer of said stack.

The invention further relates to a method of recording information on an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the step of focusing the optical beam on the first electrode of the information stack on which information is to be recorded in order to locally reduce the electrical conductance of the first electrode.

The invention also relates to a method of recording information on an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the step of focusing the optical beam on the information layer of the information stack on which information is to be recorded in order to locally degrade the information layer.

The invention also relates to a method of recording information on an information carrier by means of an optical beam, said information carrier comprising at least two information stacks, wherein each stack comprises a first electrode, a second electrode and an information layer between the first and second electrodes, wherein the information layer comprises a matrix comprising two types of surface-charged colloidal particles, one with negative charge and one with positive charge, said surface-charged colloidal particles comprising liquid crystal molecules, said matrix having a viscosity which can be locally reduced by means of the optical beam, said method comprising the steps of focusing the optical beam on the information layer of the information stack on which information is to be recorded in order to locally reduce the viscosity of the matrix of said information layer, and applying a potential difference between the first and second electrodes of said stack.

The invention further relates to a method of erasing information on an information layer where information has been recorded according to the method as described hereinbefore, said method of erasing comprising the steps of focusing the optical beam on said information layer in order to locally reduce the viscosity of the matrix of said information layer, and applying a different potential difference between the first and second electrodes of said stack.

These and other aspects of the invention will be apparent from and will be elucidated with reference to the embodiments described hereinafter.

### BRIEF DESCRIPTION OF THE DRAWINGS

The invention will now be described in more detail, by way of example, with reference to the accompanying drawings, in which:

FIGS. 1a and 1b show a first ROM information carrier in accordance with the invention;

FIGS. 2a, 2b, and 2c show a second, a third and a fourth ROM information carrier in accordance with the invention;

FIGS. 3a, 3b, 3c and 3d show a first, a second, a third and a fourth WORM information carrier in accordance with the invention;

FIG. 4 shows a structure of an unwritten information layer in a RW information carrier in accordance with the invention;

FIG. 5 shows a structure of a written information layer in a RW information carrier in accordance with the invention;

FIG. 6 shows an optical device in accordance with the invention.

### DETAILED DESCRIPTION OF THE INVENTION

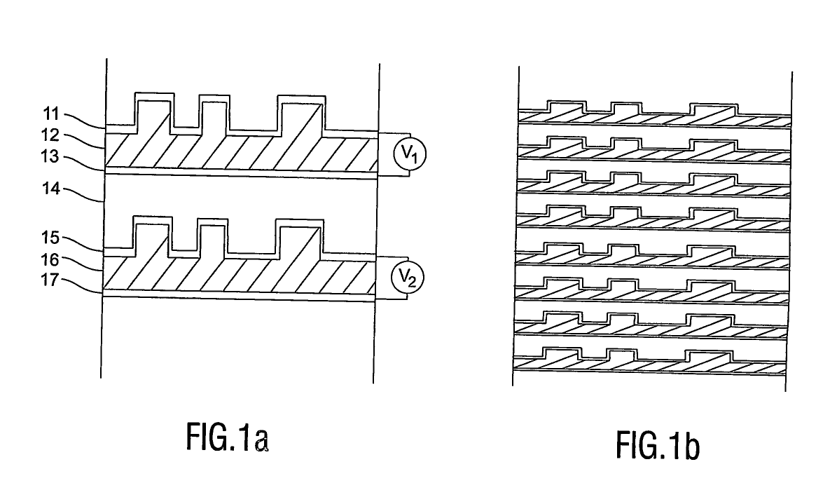

A first ROM (Read Only Memory) information carrier in accordance with the invention is depicted in FIG. 1a. Such an information carrier comprises a first, a second, a third and a fourth electrode 11, 13, 15 and 17, a first and a second information layer 12 and 16 and a spacer layer 14. The first electrode 1, the first information layer 12 and the second electrode 13 form a first information stack, the third electrode 15, the second information layer 16 and the fourth electrode 17 form a second information stack. The two information stacks are separated by the spacer layer 14. An information carrier in accordance with the invention may comprise more than two information stacks. For example, an information carrier in accordance with the invention may comprise 10, 20 or up to 100 or more information stacks. For example, an information carrier in accordance with the invention, which comprises 8 information stacks, is depicted in FIG. 1b.

This information carrier is a ROM (Read Only Memory) information carrier, which means that a user cannot record information on this carrier. The information is recorded during a manufacturing process and cannot be erased. The information layers 12 and 16 comprise pits and lands, which are obtained by means of conventional techniques, such as embossing and printing.

This information carrier is intended to be scanned by an optical beam, which has a wavelength 1. The first, second, third and fourth electrodes 11, 13, 15 and 17 as well as the spacer layer 14, are chosen to be transparent at the wavelength 1, or at least to have a very low absorption at this wavelength, in order not to interact with the optical beam.

An information layer of an information stack comprises molecules which can be rotated with respect to their initial orientation when a suitable potential difference is applied between the first and second electrodes. A DC voltage may be used to accomplish this, but preferably an AC voltage is used.

In order to obtain the second information layer 16, a layer comprising these molecules is patterned, by conventional techniques such as embossing. Then, the third electrode 15 is deposited on the patterned second information layer 16, by means of conventional techniques such as spin coating, dip coating, vapour deposition or sputter deposition. Then, the spacer layer 14 is deposited, for example by spin coating, and the second electrode 13 is deposited on the spacer layer 14. Then, a layer comprising said molecules is deposited on the second electrode 13. This layer is patterned in order to obtain the first information layer 12. These operations are repeated in order to obtain an information carrier comprising a plurality of information stacks.

Molecules having an ability to turn towards a given direction when a potential difference is applied between electrodes are, for example, liquid crystal molecules. Such liquid crystal cells are described, for example, in “Handbook of Liquid Crystal Research”, by Peter J. Collings, Jay S. Patel, Oxford University Press, New York, 1997. For example, when a suitable potential difference is applied between the first and second electrodes 11 and 13, an electric field is created, which has a direction substantially orthogonal to the first and second electrodes 11 and 13. When subjected to this electric field, the liquid crystal molecules of the first information layer 12 will turn towards the direction of the electric field.

This is true when liquid crystal molecules having a positive dielectric anisotropy are used. However, liquid crystal molecules having a negative dielectric anisotropy may also be used in accordance with the invention. In this case, the liquid crystal molecules of the first information layer 12 turn towards a direction that is perpendicular to the direction of the electric field. The following description applies to liquid crystal molecules having a positive dielectric anisotropy.

Furthermore, an information layer may comprise a single type of liquid crystal molecules, or a mixture of two or more types of liquid crystal molecules. Moreover, an information layer may exhibit one or more temperature-dependent or concentration-dependent liquid crystal phases, such as a nematic phase, smectic phase, chiral nematic phase, ferroelectric phase or discotic phase.

Furthermore, an information layer may incorporate other components. For instance, the liquid crystal molecules may be incorporated within an isotropic or anisotropic network, as described for example in “Liquid crystals in complex geometries. Formed by polymer and porous networks”, by R. A. M. Hikmet, edited by G. P. Crawford, S. Zumer, published by Taylor & Francis, London, 1996. Such a network-enforced liquid crystal layer may for example be created in-situ in that a previously applied reactive mixture is irradiated with UV-light, as is described in this reference for instance.

When no potential difference is applied between the first and second electrodes 11 and 13, the liquid crystal molecules of the first information layer 12 are randomly directed, so that the first information layer 12 is substantially transparent at the wavelength 1. When a suitable potential difference is applied between the first and second electrodes 11 and 13, the liquid crystal molecules of the first information layer 12 turn towards the direction of the electric field created by said potential difference, which results in the first information layer 12 becoming absorbent and/or reflective at the wavelength 1. This is a consequence of a change in index of refraction, which results from the re-orientation of the liquid crystal molecules of the first information layer 12.

The molecules used in accordance with the invention may also be molecules comprising a charged substituent which turn towards the direction of a current created by the potential difference applied between two electrodes. Examples of such molecules are ionomers or polyelectrolytes. Polyelectrolytes or ionomers consist of ion-containing polymers, consisting of polymeric backbones with a relatively small number of monomer units with an ionic functionality either as a pendant group or incorporated in the main chain. Mostly, structures with carboxylic, sulfonic, or phosphoric acids can be used, which are partially or fully neutralized with cations. These materials are described in, for instance, “Ionic Polymers”, by L. Holliday, Applied Science Publishers, London, 1975. Particular examples of these materials are for example poly(2-acrylamido-2-methylpropanesulphonic acid), poly(ethylene sulphonic acid), poly(styrene sulphonic acid), and zinc or sodium salts of copolymers such as poly(ethylene-co-methyl acrylic acid).

Optionally, these polyelectrolytes or ionomers may be modified so as to comprise mesogenic units, present in the polymeric main-chain, side-chain or both. Specific examples of such liquid crystalline ionomers are described, for example, in “Liquid-crystalline ionomers”, by Wilbert et al., Macromolecular Symposia (1997), 117 229-232.

Furthermore, optional additives such as solvent, co-solvent, or softening additives may be used along with the employed ionomers or polyelectrolytes in order to adjust the viscosity of the information layer, and to facilitate and optimise the reorientation of the materials.

When no potential difference is applied between the first and second electrodes 11 and 13, the molecules of the first information layer 12 are randomly directed, so that the first information layer 12 is substantially transparent at the wavelength 1. When a suitable potential difference is applied between the first and second electrodes 11 and 13, the molecules of the first information layer 12 all turn towards a certain direction, which results in the first information layer 12 becoming absorbent and/or reflective at the wavelength 1.

This direction depends on the nature of the materials used in the first information layer 12. If the first information layer 12 only comprises charged substituents, this direction is the direction of the current created by said potential difference. If the information layer comprises charged substituents containing mesogenic units, the direction depends on the nature of the liquid crystal molecules of the mesogenic units.

The following description applies to information layers comprising liquid crystal molecules. A similar description applies to information layers comprising molecules with a charged substituent, optionally containing mesogenic units.

When the first information layer 12 is scanned for reading information from this first information layer 12, a potential difference V1 is applied between the first and second electrodes 11 and 13. An electric field is thus created between the first and second electrodes 11 and 13. Thus, the liquid crystal molecules of the first information layer 12 turn towards the direction of this electric field, i.e. a direction substantially orthogonal to the first and second electrodes 11 and 13. As a consequence, the first information layer 12 becomes absorbent and/or reflective at the wavelength 1.

The potential difference V1 is chosen so that, when it is applied, the absorption and reflection of the first information layer 12 become relatively high at the wavelength 1. The potential difference V1 depends on the wavelength 1, the chemical structure of the liquid crystal molecules, the layer thickness of the first information layer 12 and the first and second electrodes 11 and 13. Examples of materials which may be used for the first and second electrodes 11 and 13 are ITO (Indium Tin Oxide), PEDOT (poly(3,4-ethylenedioxythiophene)) and PPV (poly(phenylenevinylene)).

Then, once the absorption and/or reflection of the first information layer 12 is high, information can be read from this information layer using conventional read-out techniques, such as the phase difference read-out principle used, for example, for read-out of CD-ROM, and amplitude difference readout.

Once the information of the first information layer 12 has been read, the second information layer 16 is scanned. First, the first information layer 12 is made transparent in that the potential difference V1 is removed. The electric field between the first and second electrodes 11 and 13 disappears, the liquid crystal molecules rotate back to their initial orientation and the first information layer 12 thus becomes transparent.

Then, the second information layer 16 is made absorbent in that a potential difference V2, is applied between the third and fourth electrode 15 and 17. In this example, V2 is equal to V1, because the first and second information stacks comprise the same liquid crystal molecules. If different molecules having an ability to turn towards a given direction are used in the first and second information layers 12 and 16, V2 may differ from V1. Also if the layer thicknesses of the information layers 12 and 16 are different, a different potential difference may be needed.

Once the second information layer 16 is absorbent and/or reflective, information can be read from this second information layer 16. The first information layer 12 does not perturb read-out of information, because the first information layer 12 has been made transparent. As a consequence, it is possible to address only one information layer, while the rest of the information carrier is substantially transparent. The desired layer is addressed by application of the suitable potential differences between the electrodes of the different information stacks.

If the first information layer 12 is sufficiently transparent in the reflecting and/or absorbing state, it is also possible to switch the first information layer 12 to the transparent state not before but after the second information layer 16 has been made absorbing and/or reflective.

An information carrier in accordance with the invention, comprising the abovementioned layers, may be manufactured by conventional techniques, such as embossing, moulding, photolithographic techniques, micro-contact printing or vapour deposition.

In the description hereinbefore, the liquid crystal molecules are randomly oriented when no potential difference is applied between the first and second electrodes. When a potential difference is applied, they turn towards a direction, which is parallel or perpendicular to the electric field created by the potential difference, depending on the nature of the liquid crystal molecules.

It should be noted that the liquid crystal molecules can also be oriented in a certain direction when no potential difference is applied, this direction being changed when a potential difference is applied between the first and second electrodes. For example, the liquid crystal molecules may be parallel to the first and second electrodes when no potential difference is applied, assuming that this orientation results in a transparent information layer. Then, when a voltage difference is applied, the liquid crystal molecules turn towards a direction perpendicular to the first and second electrodes, in which case the considered information layer becomes absorbent and/or reflective.

In the latter case, the liquid crystal molecules should return to their initial orientation when the potential difference is removed. This may be achieved in that an anisotropic network is used for the information layer. For example, if the orientation of the liquid crystal molecules is planar when no potential difference is applied, i.e. parallel to the first and second electrodes, a planarly oriented anisotropic network is used in combination with liquid crystal molecules having a positive dielectric anisotropy. If the orientation of the liquid crystal molecules is homeotropic when no potential difference is applied, i.e. perpendicular to the first and second electrodes, a homeotropically oriented anisotropic network is used in combination with liquid crystal molecules having a negative dielectric anisotropy.

Alternatively, a chemical or mechanical modification of the first and second electrodes may be performed, in order to induce a preferred orientation of the liquid crystal alignment when no voltage is applied.

Alternatively, additional alignment layers that enclose the information layer may be used. An additional information layer is placed between an electrode and the information layer of an information stack. Both alignment layers are preferred, although the use of only one of these alignment layers is also possible.

Alignment layers may be used such as those typically used for the construction of conventional liquid crystal displays, such as rubbed polyimide alignment layers, or photoalignment layers, such as coumarin derivatives or cinnamate derivatives. Deposition of these layers may again be accomplished by conventional processing techniques, such as spin coating or dip coating. Depending on the type of alignment layer, subsequent rubbing is required or a brief UV-exposure, to induce the desired orientation. The used alignment layers enclosing the information layer are preferably the same, but may also be different. A benefit of the use of polyimides is their outstanding temperature stability, which is well above the typical degradation temperatures that are commonly observed for the majority of organic polymers.

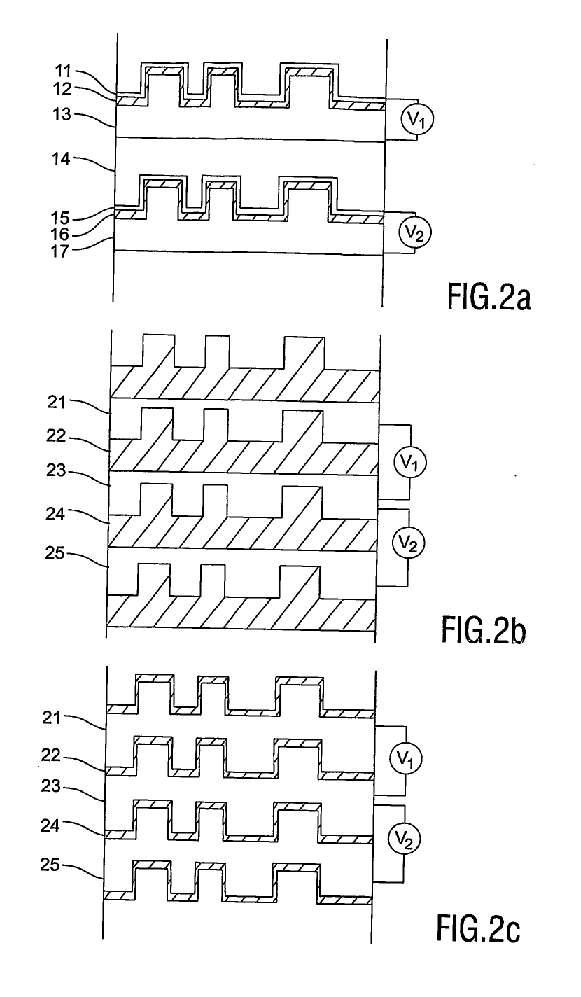

FIG. 2a shows a second ROM information carrier in accordance with the invention. In this Figure, numbers identical to those in FIG. 1a stand for the same entities. This information carrier comprises a first, a second, a third and a fourth electrode 11, 13, 15 and 17, a first and a second information layer 12 and 16 and a spacer layer 14. The first electrode 11, the first information layer 12 and the second electrode 13 form a first information stack, the third electrode 15, the second information layer 16 and the fourth electrode 17 form a second information stack. The two information stacks are separated by the spacer layer 14.

An example of a manufacturing process for making the information carrier of FIG. 2a is described hereinafter. The fourth electrode 17 is patterned by conventional techniques, such as embossing. Then, the second information layer is deposited on the patterned fourth electrode 17, and the third electrode 15 is deposited on the second information layer 16. Then, the spacer layer 14 is deposited on the third electrode 15, and the second electrode 13 is deposited on the spacer layer 14. The operations described above are then repeated in order to obtain an information carrier comprising a plurality of information stacks.

In order to address the first and the second information layers 12 and 16, the potential differences are applied between the first and second electrodes 11 and 13, and the third and fourth electrodes 15 and 17, respectively.

FIG. 2b shows a second ROM information carrier in accordance with the invention. This information carrier comprises a first, a second and a third electrode 21, 23 and 25, and a first and a second information layer 22 and 24. The first electrode 21, the first information layer 22 and the second electrode 23 form a first information stack, the second electrode 23, the second information layer 24 and the third electrode 25 form a second information stack.

An example of a manufacturing process for making the information carrier of FIG. 2b is described hereinafter. A layer comprising liquid crystal molecules is patterned by conventional techniques, such as embossing or printing. The second information layer 24 is obtained. Then, the second electrode 23 is deposited on the patterned second information layer 24, and a layer comprising liquid crystal molecules is deposited on the second electrode 23. The operations described above are then repeated in order to obtain an information carrier comprising a plurality of information stacks.

In order to address the first and the second information layers 22 and 24, the potential differences are applied between the first and second electrodes 21 and 23, and the second and third electrodes 23 and 25, respectively.

FIG. 2c shows a third ROM information carrier in accordance with the invention. This information carrier comprises a first, a second and a third electrode 21, 23 and 25, and a first and a second information layer 22 and 24. The first electrode 21, the first information layer 22 and the second electrode 23 form a first information stack, the second electrode 23, the second information layer 24 and the third electrode 25 form a second information stack.

An example of a manufacturing process for making the information carrier of FIG. 2c is described hereinafter. The third electrode 25 is patterned by conventional techniques, such as embossing. Then, the second information layer 24 is deposited on the patterned third electrode 25, and the second electrode 23 is deposited on the second information layer 24. The second electrode 23 is then patterned, and the first information layer 22 is deposited on the patterned second electrode 23. The operations described above are repeated in order to obtain an information carrier comprising a plurality of information stacks.

In order to address the first and the second information layers 22 and 24, the potential differences are applied between the first and second electrodes 21 and 23, and the second and third electrodes 23 and 25, respectively.

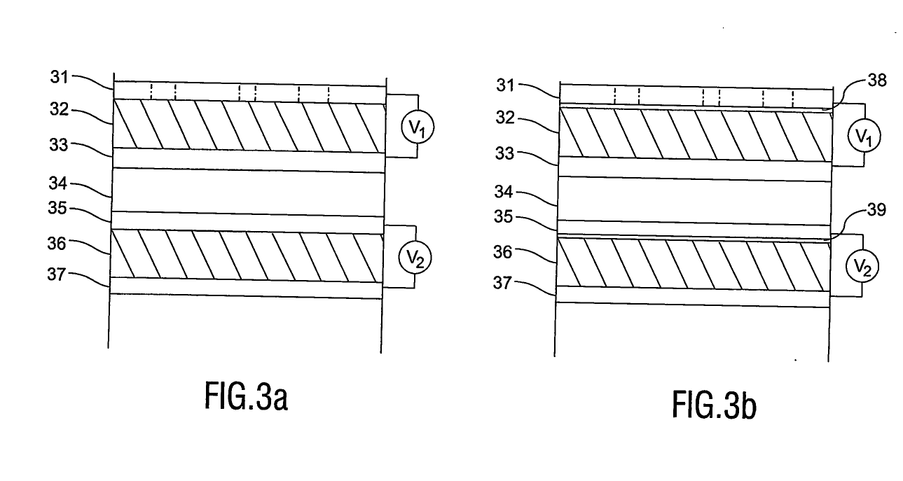

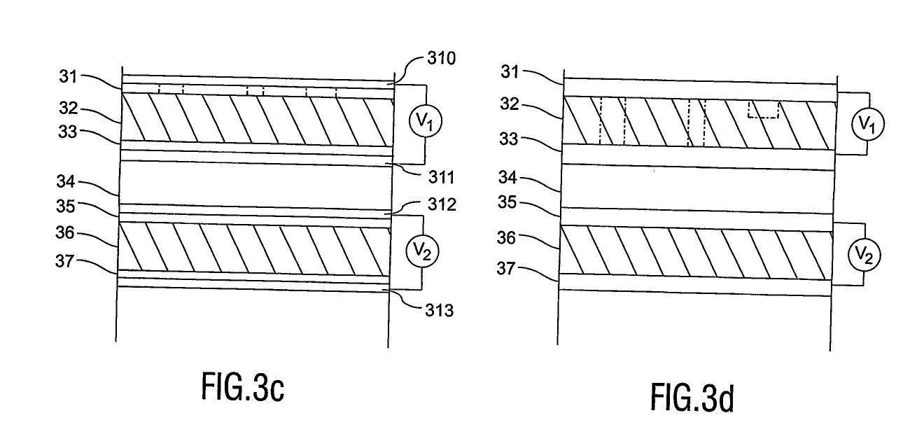

FIG. 3a shows a first WORM (Write Once Read Many) information carrier in accordance with the invention. This information carrier comprises a first, a second, a third and a fourth electrode 31, 33, 35 and 37, a first and a second information layer 32 and 36 and a spacer layer 34. The first electrode 31, the first information layer 32 and the second electrode 33 form a first information stack, the third electrode 35, the second information layer 36 and the fourth electrode 37 form a second information stack. The two information stacks are separated by the spacer layer 34.

The first and third electrodes 31 and 35 have an electrical conductance which can be locally reduced by means of the optical beam at the wavelength 1. In order to locally reduce the electrical conductance of the first and third electrodes 31 and 35, a relatively high power of the optical beam is required. The high power is absorbed in the material and changes its material properties, for example by melting, annealing, photochemical reactions, thermal damaging or deterioration. This relatively high power is used during writing of information on the information carrier, whereas a lower power is used during reading, which power is not able to reduce the electrical conductance of the first and third electrodes 31 and 35.

In order to write information on the first information layer 32, the optical beam having the relatively high power is focused on the first electrode 31, in order to locally reduce the electrical conductance of this first electrode 31, for writing marks. In FIG. 3a, the marks where the electrical conductance of the first electrode 31 is reduced are represented by dotted lines.

In order to write information on the second information layer 36, the optical beam having the relatively high power is focused on the third electrode 35, in order to locally reduce the electrical conductance of this third electrode 35.

In order to read information from the first information layer 32, a suitable voltage V1 is applied between the first electrode 31 and the second electrode 33. An electric field is created between the first and second electrodes 31 and 33, except where marks have been written, because the electrical conductance of these marks is too small for allowing creation of an electric field. Hence, the liquid crystal molecules of the first information layer 32 are subjected to an electric field, except in the parts located under the marks written in the first electrode 31. As a consequence, the first information layer 32 becomes absorbent and/or reflective, except in the parts located under the written marks.

The difference in absorption and reflection between the parts under the marks and the parts under the non-marked areas is thus used for reading information from the first information layer 32.

In order to read information from the second information layer 36, the first information layer 32 is made transparent at the wavelength 1, in that the potential difference V1 is removed. Hence, the whole first information layer 32 becomes transparent. Hence, the first information layer 32 does not perturb the scanning of the second information layer 36. Then, the second information layer 36 is made absorbent and/or reflective at the wavelength 1, in that a suitable voltage V2, equal to V1, is applied between the third electrode 35 and the fourth electrode 37. The second information layer 36 becomes absorbent and/or reflective, except in the parts located under the marks written in the third electrode 35. Information can then be read from the second information layer 36.

It should be noted that the thicknesses of the layers compared with the mark width represented in FIG. 3a do not necessarily correspond to reality. It is advantageous that the thickness of an information layer is smaller than the width of a mark. If the thickness of an information layer is greater than the width of a mark, an electric field may be created even in parts located under marks. The parts where the liquid crystal molecules are subjected to an electric field may then be larger than desired, thus reducing the data capacity of such an information carrier. For optical recording, the marks are typically larger than 500 nanometres. As a consequence, a thickness of the information layer below 300 nanometres is preferred, in order to avoid creation of an electric field in a part located under a written mark.

It should also be noted that the information layer preferably has a decomposition temperature which is higher than the temperature at which the electrical conductance of the first electrode is reduced. Even if the optical beam is not directly focused on the information layer during writing, the information layer will still reach a temperature which is not far from the temperature of the electrode in which marks are written.

However, an information layer having a decomposition temperature lower than the temperature at which the electrical conductance of the first electrode is reduced may be used in a WORM information carrier in accordance with the invention, as explained in FIG. 3b. In FIG. 3b, the information carrier further comprises a first and a second thermal insulation layer 38 and 39, which are placed between the first electrode 31 and the first information layer 32, and between the third electrode 35 and the second information layer 36, respectively.

The first and second thermal insulation layers 38 and 39 are chosen so as to be transparent at the wavelength 1, and to have a decomposition temperature higher than the temperature at which the electrical conductance of the first and third electrodes 31 and 35 is reduced. For example, a ZnS—SiO2 layer may be used as thermal insulation layer, as well as high-temperature resistant polymers, such as polyimides, polyetherimides, polyesterimides, polyamidimides, polyamides, polymetylpentene, polyetheretherketone, and polyethersulfone. The first and second thermal insulation layers 38 and 39 have a relatively low thermal conductivity. As a consequence, the temperature of the first and second information layers 32 and 36 during writing is lower than the temperature of the first and third electrodes 31 and 35. Hence, the first and second information layers 32 and 36 may have a relatively low decomposition temperature.

FIG. 3c shows a third WORM information carrier in accordance with the invention. Compared with the first WORM information carrier of FIG. 3a, this information carrier further comprises a first, a second, a third and a fourth additional electrode 310 to 313. The additional electrodes serve to overcome the local increase in electrical resistance when the first and third electrodes 31 and 35, in which marks are written, are partially degraded. Organic conducting polymers with a high degradation temperature or inorganic layers such as ITO (Indium-Tin-Oxide) may be used as additional electrodes.

FIG. 3d shows a fourth WORM information carrier in accordance with the invention. This information carrier comprises a first, a second, a third and a fourth electrode 31, 33, 35 and 37, a first and a second information layer 32 and 36 and a spacer layer 34. The first electrode 31, the first information layer 32 and the second electrode 33 form a first information stack, the third electrode 35, the second information layer 36 and the fourth electrode 37 form a second information stack. The two information stacks are separated by the spacer layer 34.

The information layers can be locally degraded, e.g. annealed, altered, molten, fixed, photochemically or deteriorated by means of an optical beam. In order to locally degrade the first and second information layers 32 and 36, a relatively high power of the optical beam is required. The high power is absorbed in the material and changes its material properties, for example by melting, annealing, photochemical reactions, thermal damaging or deterioration. This relatively high power is used during writing of information on the information carrier, whereas a lower power is used during reading, which power is not able to degrade the first and second information layers 32 and 36.

A local degradation of an information layer of an information stack results in the molecules in a degraded area losing their ability to rotate when a potential difference is applied between the first and second electrodes of this information stack. Hence, degraded areas remain transparent, whatever the potential difference applied between the first and second electrodes of this information stack.

In order to write information on the first information layer 32, the optical beam having the relatively high power is focused on the first information layer 32, in order to locally degrade this first information layer 32, for writing marks. In FIG. 3d, the marks where the first information layer 32 is degraded are represented by dotted lines. The depth of the marks in the information layers can be chosen in that the power of the optical beam is varied, or the time during which the optical beam is focused on a mark is varied. Having different mark depths allows multilevel recording. In single-level recording, typically two reflection states or levels are used, whereas more reflection levels are defined to represent data in the case of multi-level recording.

In order to write information on the second information layer 36, the optical beam having the relatively high power is focused on the second information layer 36, in order to locally degrade this second information layer 36, for writing marks.

The information layer on which information has to be written may be made absorbent before the relatively high power optical beam is focused on it. This improves absorption of the relatively high-power optical beam, which increases the local degradation of the information layer.

In order to read information from the first information layer 32, this first information layer 32 is made absorbent at the wavelength 1, in that a suitable voltage V1 is applied between the first electrode 31 and the second electrode 33. The first information layer 32 becomes absorbent and or/reflective, except where marks have been written, because the molecules of these marks cannot rotate. Hence, the difference in absorption and/or reflection between the marks and the non-marked areas in the first information layer 32 is used for reading information from the first information layer 32.

In order to read information from the second information layer 36, the first information layer 32 is made transparent at the wavelength 1, in that the potential difference V1 is removed between the first electrode 31 and the second electrode 33. Hence, the whole first information layer 32, including the marks, becomes transparent. The first information layer 32 accordingly does not perturb the scanning of the second information layer 36. Then, the second information layer 36 is made absorbent and/or reflective at the wavelength 1, in that a suitable voltage V2, equal to V1, is applied between the third electrode 35 and the fourth electrode 37. The second information layer 36 becomes absorbent and/or reflective, except where marks have been written. Information can then be read from the second information layer 36.

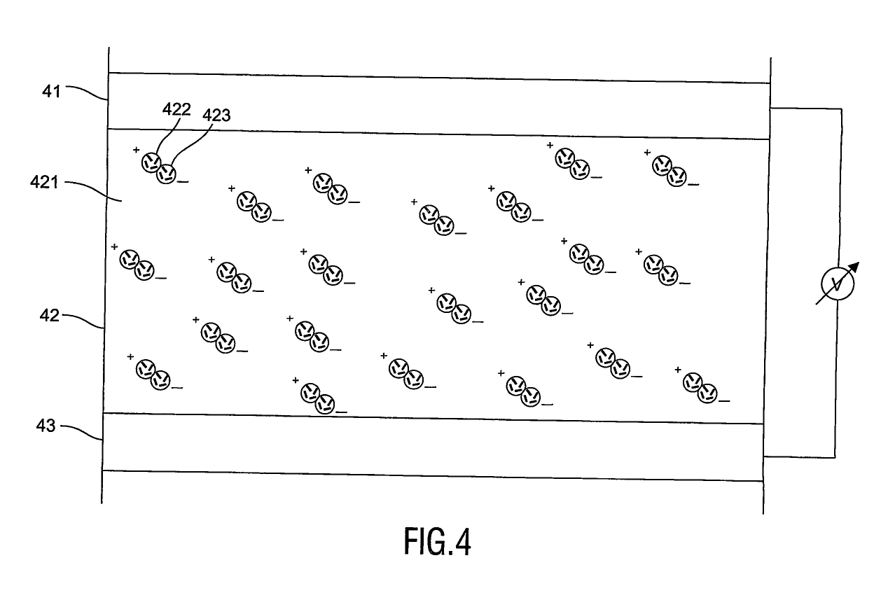

FIG. 4 shows the structure of an unwritten RW (ReWritable) information carrier in accordance with the invention. In FIG. 4, only one information stack of the information carrier is represented, the other information stacks being similar. This information stack comprises a first and a second electrode 41 and 43, and an information layer 42. The information layer comprises a matrix 421 and surface-charged colloidal particles, such as particles 422 and 423. The surface-charged colloidal particles are represented by spheres, and comprise liquid crystal molecules, represented by short rods. The representation by rods does not limit the use of liquid crystals to be calamitic, but also banana-shaped or discotic liquid crystals may be used. The matrix 421 has a viscosity which can be locally reduced by means of the relatively high power optical beam at the wavelength 1, in order to write information on the information layer 42. During read-out of information, an optical beam having a lower power is used, which cannot reduce the viscosity of the matrix 421. The matrix 421 is chosen to be transparent at the wavelength 1.

The matrix 421 may consist of a material having a temperature-dependent transition, which may be a first order transition, a second order transition, or a glass transition. Preferably, this transition will be situated well above ambient temperature, and well above the typical upper limit handling temperature of the information carrier, but below the degradation temperature of adjacent layers within the information carrier. The matrix may furthermore have an inorganic nature, but preferably has an organic nature, such as polymeric nature. In particular, a polymeric matrix may consist, for example, of homopolymers, copolymers or polymer blends. Examples of polymers having a temperature-dependent transition, such as a glass transition, are polystyrene and polymethylmethacrylate.

A method of obtaining liquid crystal molecules embedded in charged colloidal particles is known tp those skilled in the art. For example, encapsulated liquid crystals are known from the display-related polymer dispersed liquid crystal (PDLC) switches, as described, for example, in “Liquid crystal dispersions”, by P. S. Drzaic, World Scientific, Singapore, 1995. However, the position of the liquid crystal droplets is fixed by the usually crosslinked matrix. The synthesis and use of separately encapsulated liquid crystals, or liquid crystal microcapsules, that can subsequently be dispersed in a matrix has been described in, for example, S.-A. Cho, N.-H. Park, J.-W. Kim, K.-D. Suh, Colloids and surfaces, A: Physicochemical and engineering aspects, 196, 217 (2002).

Various liquid crystal molecules may be used in an information carrier as depicted in FIG. 4. For example, liquid crystal molecules having a positive or negative dielectric anisotropy may be employed. Also, the type of liquid crystal molecules can be chosen from, for example, calamitic, banana-shaped, and discotic types.

When the information layer 42 is unwritten, the surface-charged colloidal particles are randomly dispersed in the matrix 421. As shown in FIG. 4, the positively surface-charged colloidal particles may cluster with the negatively surface-charged particles in order to form stable aggregates.

In this situation, the information layer 42 is substantially transparent at the wavelength 1, whatever the potential difference applied between the first and second electrodes 41 and 43. Actually, the surface-charged particles comprising liquid crystal molecules are colloidal, which means that the volume fraction of surface-charged particles compared with the volume of the matrix 421 is relatively small. For example, this volume fraction is lower than 10 percent. Preferably, this volume fraction is lower than 5%. It is also possible to use different liquid molecules in the positively surface-charged particles and in the negatively surface-charged particles to enhance the contrast of the recorded information layer.

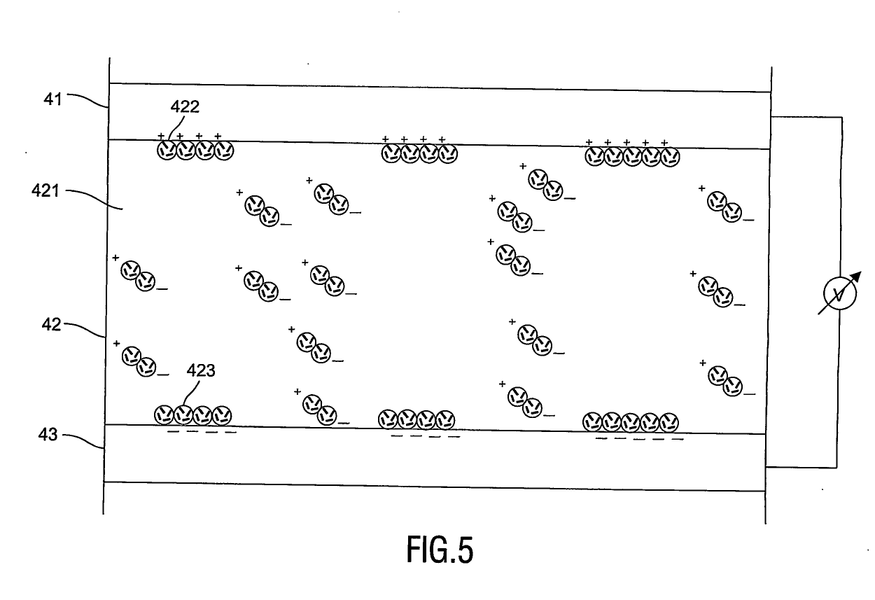

In order to write a mark on the information layer 42, the relatively high power optical beam is focused on this mark. The part of the matrix 421 located under this mark is heated, and reaches a temperature at which its viscosity is reduced. A suitable potential difference V1 is applied between the first and second electrodes 41 and 43, which creates an electric field in the information layer 42, whereby the negatively charged colloidal particles are separated from the positively charged colloidal particles. A written information layer is thus obtained, which is represented in FIG. 5.

FIG. 5 shows the structure of a written RW information carrier in accordance with the invention. In this Figure, numbers identical to those in FIG. 4 stand for the same entities.

In the parts of the information layer 42 where a mark has been written, the positively surface-charged particles are captured at the surface of the negative electrode, which is, in this case, the first electrode 41, and the negatively surface-charged particles are captured at the surface of the positive electrode, which is, in this case, the second electrode 43. Once a mark has been written, the relatively high-power optical beam is no longer focused on this mark. Hence, the part of the matrix 421 located under this written mark cools down while the potential difference is maintained during cooling down, and the charged particles remain at the respective electrode surface, because the viscosity of the matrix 421 prevents a transport of these charged particles.

As a consequence, once information has been recorded on the information layer 42, this first information layer 42 comprises written parts, where surface-charged particles are captured at the surfaces of the first and second electrodes 41 and 43, and unwritten parts, where the surface-charged particles are randomly dispersed in the matrix 421.

In order to read information from the information layer 42, the low-power optical beam is focused on this information layer, and a suitable potential difference V2 is applied between the first and second electrodes 41 and 43. The potential difference V2 may differ from V1. Actually, the potential difference V1 is used for enabling transport of the charged particles in the matrix 421, whereas the potential difference V2 is used for rotating the liquid crystal molecules.

As explained in the description of FIG. 4, the unwritten parts of the information layer 42 remain transparent, even if the liquid crystal molecules in these unwritten parts are subjected to an electric field, because the volume fraction of charged particles compared with the volume of the matrix 421 is relatively small. However, the written parts of the information layer 42 become absorbent and reflective at the wavelength 1 when the potential difference V2 is applied between the first and second electrodes 41 and 43, because of the relatively high concentration of liquid crystal molecules in a small volume, i.e. near the first electrode 41, which molecules are all turned towards the same direction. As a consequence, the difference in absorption and/or reflection between the unwritten parts and the written parts of the information layer 42 can be used for read-out.

When another information layer of the information carrier is scanned, the information layer 42 is made transparent, in that the potential difference V2 is removed.

The information written on the information layers of the information carrier presented in FIGS. 4 and 5 can be erased, and information can be rewritten on these information layers. In order to erase information written on the information layer 42, this information layer 42 is scanned by a relatively high-power optical beam. The matrix 421 is heated, and the viscosity of this matrix 421 is reduced. A reverse potential difference −V3 is applied between the first and second electrodes 41 and 43, in order to enable transport of the charged colloidal particles in a direction opposite to the transport direction obtained during writing. The amplitude of the potential difference −V3, as well as the time during which the reverse potential −V3 is applied between the first and second electrodes 41 and 43, are chosen in order to obtain an information layer 42 as described in FIG. 4, in which the surface-charged colloidal particles are randomly dispersed in the matrix 421. Marks can then be rewritten on this information layer 42, as described above.

It is to be noted that it is possible to design a WORM information carrier with the information carrier of FIGS. 4 and 5. This is possible, for example, in that the user is prevented from applying a reverse potential difference, so that the written data cannot be erased. Such a limitation may be included, for example, in the so-called lead-in of the information carrier.

It should also be noted that multi-level recording is possible in an information carrier as depicted in FIGS. 4 and 5. By use of different times during which the potential difference V1 is applied between the first and second electrodes 41 and 43, different concentrations of positively charged particles captured at the surface of the negative electrode 41 and negatively charged particles captured at the surface of the positive electrode 43 can be obtained.

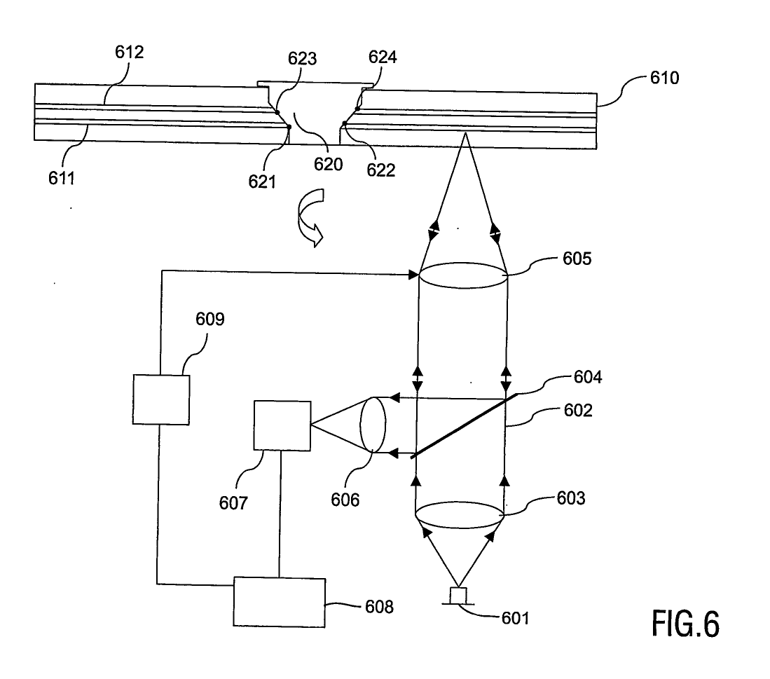

FIG. 6 shows an optical device in accordance with the invention. Such an optical device comprises a radiation source 601 for producing an optical beam 602, a collimator lens 603, a beam splitter 604, an objective lens 605, a servo lens 606, detecting means 607, measuring means 608 and a controller 609. This optical device is intended for scanning an information carrier 610. The information carrier 610 comprises two information stacks 611 and 612, each comprising at least an information layer.

During a scanning operation, which may be a writing operation or a reading operation, the information carrier 610 is scanned by the optical beam 602 produced by the radiation source 601. The collimator lens 603 and the objective lens 605 focus the optical beam 602 on an information layer of the information carrier 610. The collimator lens 603 and the objective lens 605 are focusing means. During a scanning operation, a focus error signal may be detected, corresponding to a positioning error of positioning of the optical beam 602 on the information layer. This focus error signal may be used for correcting the axial position of the objective lens 605, in order to compensate for a focus error of the optical beam 602. A signal is sent to the controller 609, which drives an actuator in order to move the objective lens 605 axially.

The focus error signal and the data written on the information layer are detected by the detecting means 607. The optical beam 602, reflected by the information carrier 610, is transformed into a parallel beam by the objective lens 605, and then reaches the servo lens 606, thanks to the beam splitter 604. This reflected beam then reaches the detecting means 607.

The optical device further comprises a damper 620 for receiving the information carrier 610. The damper 620 comprises contacts 621 to 624. These contacts 621 to 624 are designed so that, when the information carrier 610 is placed in the optical device, they allow an application of potential differences between the first and second electrodes of an information stack. In this example, when the information carrier 610 is placed in the optical device, the first contact 621 is in electrical contact with the first electrode of the first information stack 611, the second contact 622 is in electrical contact with the second electrode of the first information stack 611, the third contact 623 is in electrical contact with the first electrode of the second information stack 612 and the fourth contact 624 is in electrical contact with the second electrode of the second information stack 612. Then, potential differences are applied between the contacts. For example, in order to make the information layer of the first information stack 611 absorbent and/or reflective at the wavelength 1, a suitable potential difference is applied between the first and second contacts 621 and 622.

It should be noted that in another embodiment, the signal corresponding to information written in the information carrier 610 can be detected in transmission by a second objective lens, a second servo lens and second detecting means, which are placed opposite to the objective lens 605, the servo lens 606 and the detecting means 607, with respect to the information carrier 610.

It should also be noted that in another embodiment, the information carrier 610 may have a mirror at the back of the whole carrier, which mirror reflects the beam transmitted through all information stacks, including the addressed one. In this case, the optical scanning device as shown in FIG. 6 can be used to read the data.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. An information carrier (610) comprising at least two information stacks (611, 612), wherein each stack comprises a first electrode (11, 15), a second electrode (13, 17) and an information layer (12, 16) between the first and second electrodes, wherein the information layer comprises molecules which can be rotated when a suitable potential difference is applied between the first and second electrodes.

2. An information carrier as claimed in claim 1, wherein said molecules are liquid crystal molecules which can be rotated when subjected to an electric field created by the potential difference applied between the first and second electrodes.

3. An information carrier as claimed in claim 1, wherein said molecules comprise a charged substituent which can be rotated when subjected to a current created by the potential difference applied between the first and second electrodes.

4. An information carrier as claimed in claim 1, wherein the information layer can be locally degraded by means of an optical beam in order to write information on the information layer.

5. An information carrier as claimed in claim 1, wherein the first electrode (31, 35) has an electrical conductance which can be locally reduced by means of an optical beam in order to write information on the information layer.

6. An information carrier as claimed in claim 5, wherein the information layer (32, 36) has a thickness smaller than three hundred nanometres.

7. An information carrier as claimed in claim 5, wherein the information layer has a decomposition temperature which is higher than the temperature at which the electrical conductance of the first electrode is reduced.

8. An information carrier as claimed in claim 5, wherein the information stack further comprises a thermal insulation layer (38, 39) between the first electrode and the information layer.

9. An information carrier as claimed in claim 1, wherein the information layer (42) comprises a matrix (421) comprising two types of surface-charged colloidal particles, one with negative charge and one with positive charge (422, 423), said surface-charged colloidal particles comprising liquid crystal molecules, said matrix having a viscosity which can be locally reduced by means of an optical beam in order to write information on the information layer.

10. An optical scanning device for scanning an information carrier (610) by means of an optical beam (602), said information carrier comprising at least two information stacks (611, 612), wherein each stack comprises a first electrode, a second electrode and an information layer between the first and second electrodes, wherein the information layer comprises molecules which can be rotated when a suitable potential difference is applied between the first and second electrodes, said optical scanning device comprising means (601) for generating the optical beam, means (603, 605) for focusing said optical beam on an information layer and means for applying a potential difference between the first and second electrodes of an information stack.

11. An optical scanning device as claimed in claim 8, said optical device comprising a damper (620) for receiving the information carrier, said damper comprising contacts (621-624) for applying a potential difference between the first and second electrodes of an information stack.

12. A method of reading information from an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the steps of applying a potential difference between the first and second electrodes of the information stack from which information is to be read and focusing the optical beam on the information layer of said stack.

13. A method of recording information on an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the step of focusing the optical beam on the first electrode of the information stack on which information is to be recorded in order to locally reduce the electrical conductance of the first electrode.

14. A method of recording information on an information carrier by means of an optical beam, said information carrier comprising at least two information stacks, wherein each stack comprises a first electrode, a second electrode and an information layer between the first and second electrodes, wherein the information layer comprises molecules which can be rotated when a suitable potential difference is applied between the first and second electrodes, said method comprising the step of focusing the optical beam on the information layer of the information stack on which information is to be recorded in order to locally degrade the information layer.

15. A method of recording information on an information carrier by means of an optical beam, said information carrier comprising at least two information stacks, wherein each stack comprises a first electrode, a second electrode and an information layer between the first and second electrodes, wherein the information layer comprises a matrix comprising two types of surface-charged colloidal particles, one with negative charge and one with positive charge (422, 423), said surface-charged colloidal particles comprising liquid crystal molecules, said matrix having a viscosity which can be locally reduced by means of an optical beam, said method comprising the steps of focusing the optical beam on the information layer of the information stack on which information is to be recorded in order to locally reduce the viscosity of the matrix of said information layer, and applying a potential difference between the first and second electrodes of said stack.

16. A method of erasing information from an information layer on which information has been recorded by the method claimed in claim 15, said method of erasing comprising the steps of focusing the optical beam on said information layer in order to locally reduce the viscosity of the matrix of said information layer, and applying a different potential difference between the first and second electrodes of said stack.
